(19) United States
(12) Patent Application Publication
(10) Pub. No.: US 2025/0253748 A1
(43) Pub. Date: Aug. 7, 2025

(54) ELECTROMAGNETIC ACTUATOR ARRANGEMENT

(71) Applicant: PS Audio Design Oy, Oulu (FI)

(72) Inventor: Petteri Luukkanen, Oulu (FI)

(21) Appl. No.: 18/701,102

(22) PCT Filed: Nov. 17, 2022
(86) PCT No.: PCT/FI2022/050762

§ 371 Date: Apr. 12, 2024

(30) Foreign Application Priority Data
Nov. 19, 2021 (FI) 20216189

(51) Int. Cl. H02K 33/18; G08B 6/00

(52) U.S. Cl. CPC H02K 33/18; G08B 6/00

(57) ABSTRACT

An electromagnetic actuator arrangement comprises: a first assembly attachable to a surface and including first and second permanent magnets mechanically coupled to each other. The first and second permanent magnets arranged to define a space between the first and second permanent magnets and a same polarity of the first and second permanent magnets facing the space. The arrangement includes a second assembly comprising an electromagnetic coil arranged into the space between the first and second permanent magnets and configured to receive an electrical signal and, in response to the electrical signal, produce a magnetic field interacting with the first and second permanent magnets causing relative movement between the first assembly and the second assembly at least in a movement direction parallel with a direction from the first to the second permanent magnet, and a support member for attaching the electromagnetic coil to a structure.

### CROSS-REFERENCE TO RELATED APPLICATIONS

This application is a national phase of, and claims priority to, International Patent Application No. PCT/FI2022/050762 (filed 17 Nov. 2022), which claims priority to Finnish Patent Application No. 20216189 (filed 19 Nov. 2021), the entire disclosures of which are incorporated herein by reference.

### TECHNICAL FIELD

The present disclosure relates to the field of haptics, and more particularly to an electromagnetic actuator arrangement and a touch interface arrangement.

### BACKGROUND

In haptic feedback applications, it is typically desirable to create only surface vibration without audible sound, unless sound is specifically desired. However, when the electrical signal driving a haptic feedback actuator comprises also higher frequency components and/or noise, the generated haptic feedback may become audible. Also non-linearities and resonances in the mechanical construction may excite sound waves. Especially large surface areas having large sound radiating areas are more likely to amplify unwanted sounds.

### BRIEF SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

t is an object to provide an electromagnetic actuator arrangement and a touch interface arrangement. The foregoing and other objects are achieved by the features of the independent claims. Further implementation forms are apparent from the dependent claims, the description and the figures.

According to a first aspect, an electromagnetic actuator arrangement comprises: a first assembly attachable to a surface, the first assembly comprising a first permanent magnet and a second permanent magnet mechanically coupled to each other, wherein the first permanent magnet and the second permanent magnet are arranged to define a space between the first permanent magnet and the second permanent magnet and a same polarity of the first permanent magnet and of the second permanent magnet faces the space; and a second assembly comprising an electromagnetic coil arranged into the space between the first permanent magnet and the second permanent magnet and configured to receive an electrical signal and, in response to the electrical signal, produce a magnetic field interacting with the first permanent magnet and the second permanent magnet causing relative movement between the first assembly and the second assembly at least in a movement direction parallel with a direction from the first permanent magnet to the second permanent magnet, and a support member for attaching the electromagnetic coil to a structure. The arrangement can, for example, provide haptic feedback and/or sound via the surface.

According to second aspect, a touch interface arrangement comprises a touch interface surface, a frame, and the electromagnetic actuator arrangement according to the first aspect, wherein first of the assembly the electromagnetic actuator arrangement is mechanically coupled to the touch interface surface and the second assembly of the electromagnetic actuator arrangement is mechanically coupled to the frame.

Many of the attendant features will be more readily appreciated as they become better understood by reference to the following detailed description considered in connection with the accompanying drawings.

### BRIEF DESCRIPTION OF THE DRAWINGS

In the following, example embodiments are described in more detail with reference to the attached figures and drawings, in which:

FIG. 1 illustrates a cross-sectional representation of an electromagnetic actuator arrangement according to an embodiment;

FIG. 2 illustrates a cross-sectional representation of an electromagnetic actuator arrangement further comprising a casing according to an embodiment;

FIG. 3 illustrates a perspective view of an electromagnetic actuator arrangement further comprising a casing according to an embodiment;

FIG. 4 illustrates a cross-sectional representation of an electromagnetic actuator arrangement further comprising a casing according to another embodiment;

FIG. 5 illustrates a cross-sectional representation of magnetic fields during a positive current cycle according to an embodiment;

FIG. 6 illustrates a cross-sectional representation of magnetic fields during a negative current cycle according to an embodiment;

FIG. 7 illustrates a cross-sectional representation of an electromagnetic actuator arrangement according to an embodiment;

FIG. 8 illustrates a cross-sectional representation of an electromagnetic actuator arrangement according to an embodiment;

FIG. 9 illustrates a cross-sectional representation of an electromagnetic actuator arrangement according to an embodiment;

FIG. 10 illustrates a cross-sectional representation of an electromagnetic actuator arrangement further comprising at least one elastomer member according to an embodiment;

FIG. 11 illustrates a cross-sectional representation of an electromagnetic actuator arrangement further comprising at least one elastomer member according to another embodiment;

FIG. 12 illustrates a cross-sectional representation of an electromagnetic actuator arrangement further comprising at least one elastomer member according to another embodiment; and

FIG. 13 illustrates a cross-sectional representation of a touch interface arrangement according to an embodiment.

In the following, identical reference signs refer to similar or at least functionally equivalent features.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined by the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

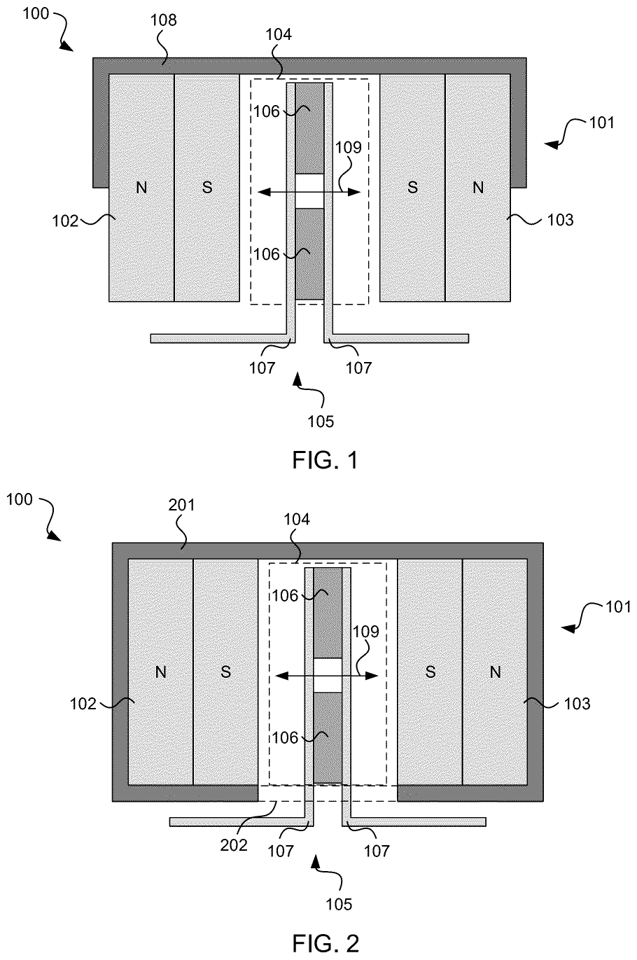

FIG. 1 illustrates a cross-sectional representation of an electromagnetic actuator arrangement according to an embodiment.

According to an embodiment, the electromagnetic actuator arrangement 100 comprises a first assembly 101 attachable to a surface, the first assembly 101 comprising a first permanent magnet 102 and a second permanent magnet 103 mechanically coupled to each other. There may be a space 104 between the first permanent magnet 102 and the second permanent magnet 103 and a same polarity of the first permanent magnet 102 and of the second permanent magnet 103 faces the space 104.

Herein, “attachable to a surface” may mean that the first assembly 101 is directly attachable to a surface or attachable to a surface via, for example, other mechanical components. For example a touch screen may be mechanically coupled to a support frame and the first assembly 101 may be attachable to such a support frame. Thus, the electromagnetic actuator arrangement 100 may be configured to provide the vibration to the touch screen via the support frame. The first assembly 101 may comprise, for example, screw holes or some other attachment means for attaching the first assembly 101 to the surface.

Herein, the surface may also be referred to as a touch surface, touch interface surface, a touch screen surface, or similar. The surface may correspond to, for example, an operating panel and/or a button of a device, a game controller surface, or a steering wheel surface.

Herein, “mechanically coupled” may mean that there is mechanical connection between the two structures in question. For example, in the embodiment of FIG. 1, the first permanent magnet 102 and the second permanent magnet 103 are mechanically coupled via a connecting member 108.

The first permanent magnet 102 and the second permanent magnet 103 may be rigidly coupled to each other. Thus, even though there may be a magnetic repulsive force between the first permanent magnet 102 and the second permanent magnet 103, the mechanical coupling can be such that the space 104 between the first permanent magnet 102 and the second permanent magnet 103 is maintained.

The same polarity of the first permanent magnet 102 and of the second permanent magnet 103 faces the space 104. For example, as is illustrated in the embodiment of FIG. 1, the south pole of the first permanent magnet 102 and the south pole of the second permanent magnet 103 may face the space 104. Alternatively, the north pole of the first permanent magnet 102 and the north pole of the second permanent magnet 103 may face the space 104.

A south-north axis of the first permanent magnet 102 may be anti-aligned with a south-north axis of the second permanent magnet 103. A south-north axis may refer to an axis pointing from the south pole of a magnet to the north pole of a magnet.

The electromagnetic actuator arrangement 100 may further comprise a second assembly 105 comprising an electromagnetic coil 106 arranged into the space 104 between the first permanent magnet 102 and the second permanent magnet 103 and configured to receive an electrical signal and, in response to the electrical signal, produce a magnetic field interacting with the first permanent magnet 102 and the second permanent magnet 103 causing relative movement between the first assembly 101 and the second assembly 105 at least in a movement direction 109 parallel with a direction from the first permanent magnet 102 to the second permanent magnet 103. The second assembly 105 may further comprise a support member 107 for attaching the electromagnetic coil 106 to a structure.

When the electrical signal comprises a time-dependent signal, such as a vibrational signal, this time-dependence can be observed in the relative movement between the first assembly 101 and the second assembly 105. This movement, such as vibration, can be transferred to the surface.

The electromagnetic actuator arrangement 100 can cause the surface to vibrate in a horizontal direction. Since a human finger is also sensitive to horizontal movement, good haptic feedback can still be achieved. Horizontal vibration excites a smaller surface area between the surface and air and therefore excites less of the air next to the surface. Thus, less audible sound pressure is created.

The electromagnetic actuator arrangement 100 can be suitable for creating vibrations in the surface. The vibrations may comprise, for example, vibrations in a direction parallel with the surface and/or vibrations in a direction perpendicular to the surface.

The coil axis of the electromagnetic coil 106 may be parallel with the south-north axis of the first permanent magnet 102 and/or with the south-north axis of the second permanent magnet 103.

A coil axis of the electromagnetic coil 106 may refer to an axis pointing along the magnetic field inside the coil when a direct current is applied to the electromagnetic coil 106.

The support member 107 may be mechanically coupled to the electromagnetic coil 106. The support member 107 can provide mechanical support, fixing, and/or cooling for the electromagnetic coil 106. The support member 107 may comprise, for example, screw holes or some other attachment means for attaching the second assembly 105 to the structure. Alternatively or additionally, the second assembly 105 may be attached to the structure using, for example, adhesive tape or dispensed glue.

Dynamic electromagnetic force can remain approximately constant when the distance between the electromagnetic coil 106 and the first permanent magnet 102 and the second permanent magnet 103 changes during relative movement. Thus, a substantially linear force can be achieved.

The first assembly 101 can be attached to a surface, such as a touch screen. The second assembly 105 can be attached to a structure, such as a support structure of a touch screen. Thus, the electromagnetic actuator arrangement 100 can cause a vibration to the surface due to the magnetic interaction between the electromagnetic coil 106 and the first permanent magnet 102 and the second permanent magnet 103. The vibration can cause, for example, haptics, haptic feedback, and/or tactile feedback on the surface and/or sound emitting from the surface.

Herein, a vibration may refer to time-dependent mechanical movement of an object. Vibration may be, for example, sinusoidal, time-limited sinusoidal, pulse-like, or any combination of these.

For example, in the embodiment of FIG. 1, the caused vibration may be along a horizontal direction. For example, if a surface is attached to the first assembly 101, the vibration may be along the surface. Since the vibration is along the surface instead of, for example, along a normal direction of the surface, sound generated by the vibration can be reduced. The vibration can still be sufficient to provide some sound effects via the vibration if required. Since the sound effects and haptics can have different frequency bands, both can be provided substantially simultaneously.

The space 104 may also be referred to as a gap, air gap, or similar. Dimensions of the space 104 can be configured to provide desired maximum free displacement, and sufficient space for the electromagnetic coil 106 and the support member 107.

There may be no direct mechanical coupling between the first assembly 101 and the second assembly 105. Thus, the first assembly 101 and the second assembly 105 may be able to move with respect to each other due to, for example, the magnetic interaction between first permanent magnet 102 and the second permanent magnet 103 and the electromagnetic coil 106.

The first assembly 101 and the second assembly 105 can slide over each other. Thus, easy top-down assembly can be achieved.

When the electromagnetic actuator arrangement 100 is in use, the first assembly 101 may be mechanically coupled, directly or via other components, to a surface and the second assembly 105 may be mechanically coupled to a structure. For example, the surface may correspond to a touch screen, a control panel, a button in a car and the structure may correspond to a support structure of the car. Thus, when the electrical signal is applied to the electromagnetic coil 106, the electromagnetic actuator arrangement 100 can provide vibration to the surface according to the electrical signal.

According to an embodiment, the electromagnetic coil 106 and/or the support member 107 comprise non-ferromagnetic materials.

For example, the electromagnetic coil 106 and/or the support member 107 may comprise only non-ferromagnetic materials, such as stainless steel, copper, and/or plastics. Thus, there may be no static magnetic forces between the first assembly 101 and the second assembly 105. Therefore, a stable mechanical structure can be achieved.

According to an embodiment, the support member 107 further comprises a ferromagnetic portion, wherein the ferromagnetic portion is closer to the first permanent magnet 102 than the second permanent magnet 103.

For example, parts of the support member 107 other than the ferromagnetic portion may be non-ferromagnetic. For example, one side of the support member 107 can be made of a ferromagnetic material or a ferromagnetic metal sheet can be added to one side of the support member 107. This can cause a static magnetic attractive force between the ferromagnetic portion and the first permanent magnet 102. The force can cause a pre-stress between the surface and the structure and can thus remove play/clearance due to mechanical tolerances. The force can be adjusted via, for example, material properties and/or size of the ferromagnetic portion.

According to an embodiment, the electrical signal comprises frequency components below 200 Hertz (Hz). Thus, the haptic feedback due to the electrical signal may comprise frequency components below 200 Hz.

The electrical signal can be provided by, for example, an audio amplifier.

Thicker and/or larger diameter permanent magnets can be used to increase the electromagnetic force without the need to change the design of the electromagnetic coil 106.

Coil wire diameter and the number of turns of the electromagnetic coil 106 can be adjusted to achieve desired electrical impedance. Longer wire length can increase the electromagnetic force.

The first permanent magnet 102, the second permanent magnet 103 and/or the electromagnetic coil 106 can have various different physical shapes, such as, circular, square, rectangular etc.

In some embodiments, the electromagnetic coil 106 can be attachable to a moving surface. However, coil cooling is typically more effective and easier when the electromagnetic coil 106 is attached to a fixed frame.

FIG. 2 illustrates a cross-sectional representation of an electromagnetic actuator arrangement further comprising a casing according to an embodiment.

According to an embodiment, the first assembly 101 further comprises a casing 201 at least partially enclosing at least one of the first permanent magnet 102 and the second permanent magnet 103.

The casing 201 can function as the connecting member 108. Thus, the first permanent magnet 102 and the second permanent magnet 103 may be mechanically coupled via the casing 201. The first permanent magnet 102 and the second permanent magnet 103 may be rigidly coupled via the casing 201.

According to an embodiment, the casing 201 encloses the first permanent magnet 102 and the second permanent magnet 103 and further comprises at least one opening 202 for the support member 107 of the second assembly 105.

According to an embodiment, the casing 201 comprises ferromagnetic material. Thus, the casing 201 can substantially contain the magnetic field generated by the first permanent magnet 102, the second permanent magnet 103, and the electromagnetic coil 106. Therefore, the magnetic interaction between the first permanent magnet 102 and the second permanent magnet 103 and the electromagnetic coil 106 can be increased. Thus, greater electrodynamic forces can be achieved.

For example, the casing 201 may be made of a ferromagnetic material. A ferromagnetic material may comprise, for example, iron, cobalt, nickel, ferromagnetic ceramics, or some combination of these.

The casing 201 may be constructed from two or more parts. The casing 201 may comprise a cup-shape around the first permanent magnet 102 and/or the second permanent magnet 103.

According to an embodiment, the first assembly 101 is attachable to the surface in an orientation in which the movement direction 109 is parallel with the surface.

For example, in the embodiment of FIG. 1 and FIG. 2, the movement direction 109 is parallel with the surface when the surface is attached to the top of the first assembly 101.

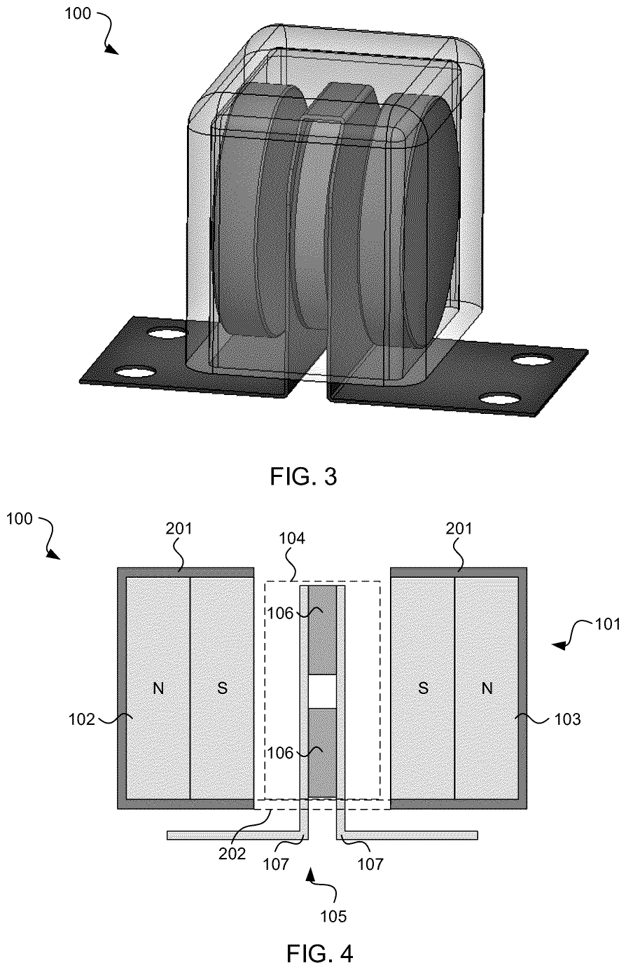

FIG. 3 illustrates a perspective view of an electromagnetic actuator arrangement further comprising a casing according to an embodiment.

The embodiment of FIG. 3 may correspond to the embodiment of FIG. 2.

FIG. 4 illustrates a cross-sectional representation of an electromagnetic actuator arrangement further comprising a casing according to another embodiment.

In the example embodiment of FIG. 4, the first assembly 101 comprises separate casings for the first permanent magnet 102 and for the second permanent magnet 103.

When the first assembly 101 comprises separate casings, the first permanent magnet 102 and the second permanent magnet 103 may be mechanically coupled via, for example, a connecting member (not illustrated in FIG. 4) similarly to the embodiment of FIG. 1. Alternatively, the first permanent magnet 102 and the second permanent magnet 103 may be mechanically coupled in some other fashion.

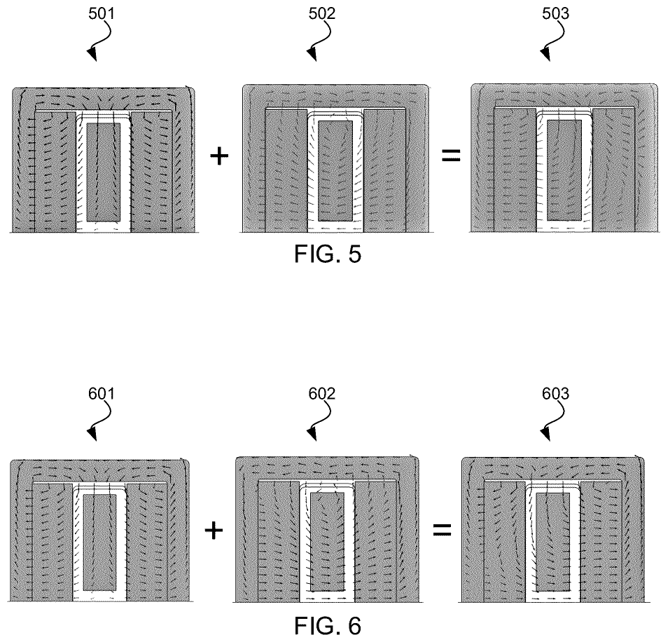

FIG. 5 illustrates a cross-sectional representation of magnetic fields during a positive current cycle according to an embodiment.

FIG. 5 illustrates a static magnetic field 501 caused by the first permanent magnet 102 and the second permanent magnet 103, a dynamic magnetic field 502 caused by the electromagnetic coil 106 during a positive current cycle in the electromagnetic coil 106 and a total magnetic field 503. The first permanent magnet 102, the second permanent magnet 103, and the electromagnetic coil 106 are enclosed in a ferromagnetic casing 201.

FIG. 6 illustrates a cross-sectional representation of magnetic fields during a negative current cycle according to an embodiment.

FIG. 6 illustrates a static magnetic field 601 caused by the first permanent magnet 102 and the second permanent magnet 103, a dynamic magnetic field 602 caused by the electromagnetic coil 106 during a negative current cycle in the electromagnetic coil 106 and a total magnetic field 603. The first permanent magnet 102, the second permanent magnet 103, and the electromagnetic coil 106 are enclosed in a ferromagnetic casing 201.

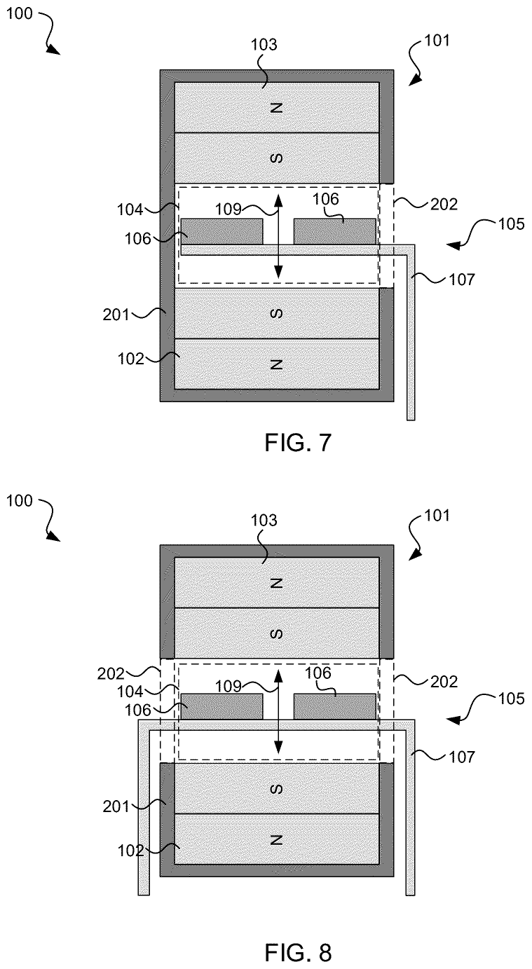

FIG. 7 illustrates a cross-sectional representation of an electromagnetic actuator arrangement according to an embodiment.

In the embodiment of FIG. 7, the movement direction 109 is vertical. Thus, when a horizontally oriented surface is attached to the first assembly 101, the electromagnetic actuator arrangement 100 can produce vibrations, such as haptic feedback and/or sound, in a direction perpendicular to the surface, i.e. along a normal direction of the surface.

FIG. 8 illustrates a cross-sectional representation of an electromagnetic actuator arrangement according to an embodiment.

In the embodiment of FIG. 8, similarly to the embodiment of FIG. 7, the electromagnetic actuator arrangement 100 is oriented such that the electromagnetic actuator arrangement 100 can provide vibration to the surface along a normal direction of the surface.

In the embodiment of FIG. 8, the casing 201 comprises two openings 202 for the support member 107. Thus, the support member 107 may be attached to the structure in two points, thus providing further structural support for the second assembly 105.

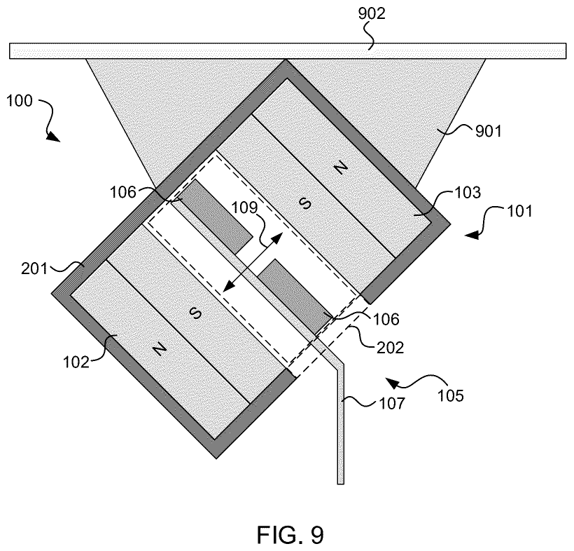

FIG. 9 illustrates a cross-sectional representation of an electromagnetic actuator arrangement according to an embodiment.

In the embodiment of FIG. 9, the electromagnetic actuator arrangement 100 is oriented such that the electromagnetic actuator arrangement 100 can provide vibration to the surface in a direction of the surface and in a direction normal to the surface.

In the embodiment of FIG. 9, the electromagnetic actuator arrangement 100 is attached to a surface 902 via an attachment structure 901. The attachment structure 901 may comprise, for example, an adhesive or any other attachment means.

According to an embodiment, the first assembly 101 is attachable to the surface 902 in an orientation in which the movement direction 109 is non-parallel with a normal direction the surface.

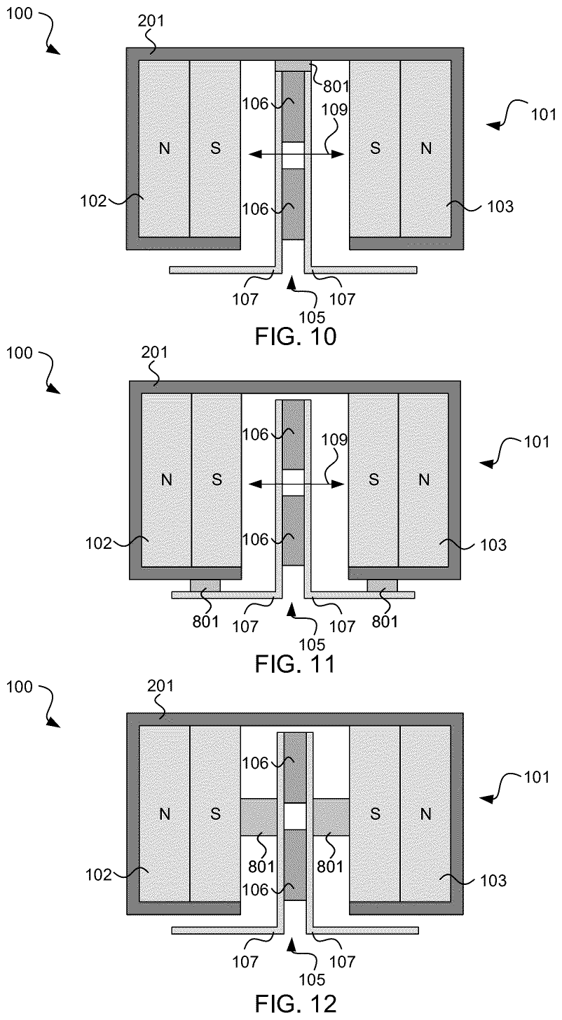

FIG. 10 illustrates a cross-sectional representation of an electromagnetic actuator arrangement further comprising at least one elastomer member according to an embodiment.

According to an embodiment, the first assembly 101 and the second assembly 105 are mechanically coupled via at least one elastomer member 108.

The at least one elastomer member 801 can maintain accurate vertical positioning between the first assembly 101 and the second assembly 105. The at least one elastomer member 801 can also allow movement along the movement direction so that the electromagnetic actuator arrangement 100 can provide the vibration to the surface.

According to an embodiment, the at least one elastomer member 801 has a first modulus of elasticity along a first direction and a second modulus of elasticity along a second direction.

According to an embodiment, the first direction is parallel with the movement direction 109, the second direction is perpendicular to the movement direction 109, and the first modulus of elasticity is less than the second modulus of elasticity.

In the embodiment of FIG. 10, the first assembly 101 is mechanically coupled to the second assembly 105 via an elastomer member 801. The elastomer member 801 mechanically couples the electromagnetic coil 106 of the second assembly 105 to the casing 201 of the first assembly 101.

In some embodiments, the elastomer member 801 can mechanically couple the electromagnetic coil 106 of the second assembly 105 to the surface if, for example, the casing 201 comprises an opening that allows such coupling.

In embodiments with no casing 201, the elastomer member 801 can mechanically couple the electromagnetic coil 106 of the second assembly 105 to, for example, the connecting member 108 of the first assembly 101.

FIG. 11 illustrates a cross-sectional representation of an electromagnetic actuator arrangement further comprising at least one elastomer member according to another embodiment.

In the embodiment of FIG. 11, the first assembly 101 is mechanically coupled to the second assembly 105 via two elastomer members 801. The elastomer members 801 mechanically couple the support member 107 of the second assembly 105 to the casing 201 of the first assembly 101.

In some embodiments, the elastomer members 801 can mechanically couple the support member 107 of the second assembly 105 to the first permanent magnet 102 and/or to the second permanent magnet 103 if, for example, the casing 201 comprises an opening that allows such coupling.

FIG. 12 illustrates a cross-sectional representation of an electromagnetic actuator arrangement further comprising at least one elastomer member according to another embodiment.

In the embodiment of FIG. 12, the first assembly 101 is mechanically coupled to the second assembly 105 via two elastomer members 801. The elastomer members 801 mechanically couple the support member 107 of the second assembly 105 to first permanent magnet 102 and the second permanent magnet 103 the first assembly 101.

The elastomer member(s) 801 can provide, for example, easier installation of the electromagnetic actuator arrangement 100 while allowing the first assembly 101 and the second assembly 105 move with respect to each other in order to provide the vibration to the surface.

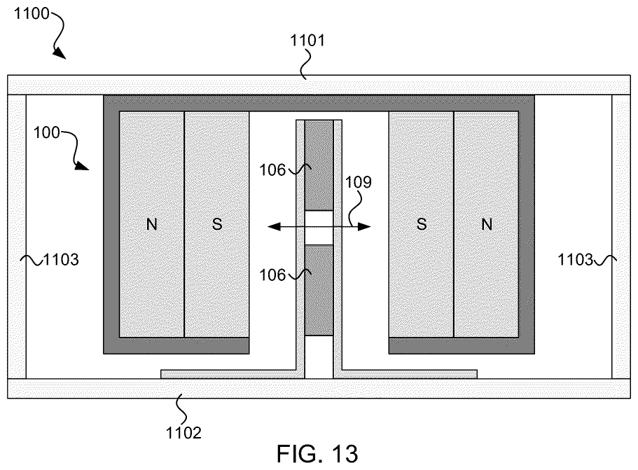

FIG. 13 illustrates a cross-sectional representation of a touch interface arrangement according to an embodiment.

According to an embodiment, a touch interface arrangement 1100 comprises a touch interface surface 1101, a frame 1102, and the electromagnetic actuator arrangement 100, wherein the first assembly 101 of the electromagnetic actuator arrangement 100 is mechanically coupled to the touch interface surface 1101 and the second assembly 105 of the electromagnetic actuator arrangement 100 is mechanically coupled to the frame 1102.

The touch interface surface 1101 may correspond to, for example, a touch screen, a control panel, or a button, for example in a control panel of a vehicle. The frame may correspond to a frame of the control panel.

According to an embodiment, the movement direction 109 of the electromagnetic actuator arrangement 100 is parallel with the touch interface surface 1101.

The touch interface surface 1101 may be elastically coupled to the frame 1102. The elastic coupling may be such that it allows the relative movement between the touch interface surface 1101 and the frame 1102 induced by the electromagnetic actuator arrangement 100. For example, in the embodiment of FIG. 13, the touch interface surface 1101 is mechanically coupled to the frame 1102 via side structures 1103. The touch interface surface 1101 may be elastically coupled to the side structures 1103. The elastic coupling may be implemented via, for example, elastic tape, at least one spring, or any other type of elastic structure(s).

According to an embodiment the touch interface arrangement 1100 further comprises a driving unit configured to provide the electrical signal to the electromagnetic coil 106 of the electromagnetic actuator arrangement 100, wherein the electrical signal is configured to cause a haptic feedback in the touch interface surface 1101 and/or a sound emitting from the touch interface surface 1101.

The driving unit may comprise, for example, an audio amplifier or any other device capable of providing the electrical signal.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. An electromagnetic actuator arrangement, comprising:
a first assembly attachable to a surface, the first assembly comprising a first permanent magnet and a second permanent magnet mechanically coupled to each other, wherein the first permanent magnet and the second permanent magnet are arranged to define a space between the first permanent magnet and the second permanent magnet with the first permanent magnet and the second permanent magnet arranged to have a same polarity of the first permanent magnet and of the second permanent magnet facing the space; and
a second assembly comprising an electromagnetic coil arranged into the space between the first permanent magnet and the second permanent magnet, the electromagnetic coil configured to receive an electrical signal and, in response to the electrical signal, produce a magnetic field interacting with the first permanent magnet and the second permanent magnet, thereby causing relative movement between the first assembly and the second assembly at least in a movement direction parallel with a direction from the first permanent magnet to the second permanent magnet, and the second assembly also including a support member for attaching the electromagnetic coil to a structure.

2. The electromagnetic actuator arrangement according to claim 1, wherein the first assembly further comprises a casing at least partially enclosing at least one of the first permanent magnet or the second permanent magnet.

3. The electromagnetic actuator arrangement according to claim 2, wherein the casing encloses the first permanent magnet and the second permanent magnet and further comprises at least one opening for the support member of the second assembly.

4. The electromagnetic actuator arrangement according to claim 2, wherein the casing comprises ferromagnetic material.

5. The electromagnetic actuator arrangement according to claim 1, wherein the first assembly is attachable to the surface in an orientation in which the movement direction is nonparallel with a normal direction the surface.

6. The electromagnetic actuator arrangement according to claim 1, wherein the first assembly is attachable to the surface in an orientation in which the movement direction is parallel with the surface.

7. The electromagnetic actuator arrangement according to claim 1, wherein the first assembly and the second assembly are mechanically coupled via at least one elastomer member.

8. The electromagnetic actuator arrangement according to claim 7, wherein the at least one elastomer member has a first modulus of elasticity along a first direction and a second modulus of elasticity along a second direction.

9. The electromagnetic actuator arrangement according to claim 8, wherein the first direction is parallel with the movement direction, the second direction is perpendicular to the movement direction, and the first modulus of elasticity is less than the second modulus of elasticity.

10. The electromagnetic actuator arrangement according to claim 1, wherein one or more of the electromagnetic coil or the support member comprise non-ferromagnetic materials.

11. The electromagnetic actuator arrangement according to claim 1, wherein the support member further comprises a ferromagnetic portion, wherein the ferromagnetic portion is closer to the first permanent magnet than the second permanent magnet.

12. A touch interface arrangement comprising a touch interface surface, a frame, and the electromagnetic actuator arrangement according to claim 1, wherein the first assembly of the electromagnetic actuator arrangement is mechanically coupled to the touch interface surface and the second assembly of the electromagnetic actuator arrangement is mechanically coupled to the frame.

13. The touch interface arrangement-according to claim 12, wherein the movement direction of the electromagnetic actuator arrangement is parallel with the touch interface surface.

14. The touch interface arrangement according to claim 12, further comprising a driving unit configured to provide the electrical signal to the electromagnetic coil of the electromagnetic actuator arrangement, wherein the electrical signal is configured to cause one or more of a haptic feedback in the touch interface surface or a sound emitting from the touch interface surface.
